(19) United States
(12) Patent Application Publication
(10) Pub. No.: US 2023/0358627 A1
(43) Pub. Date: Nov. 9, 2023

(54) Method and Device for Determining an Ambient Pressure

(71) Applicant: Vitesco Technologies GmbH, Regensburg (DE)

(72) Inventor: Thomas Riepl, Bad Abbach (DE)

(73) Assignee: Vitesco Technologies GmbH, Regensburg (DE)

(21) Appl. No.: 18/356,624

(22) Filed: Jul. 21, 2023

Related U.S. Application Data
(63) Continuation of application No. PCT/EP2021/087193, filed on Dec. 22, 2021.

(30) Foreign Application Priority Data
Jan. 21, 2021 (DE) 10 2021 200 536.5

(51) Int. Cl. G01L 7/08; G01D 3/036

(52) U.S. Cl. CPC G01L 7/088; G01D 3/0365

(57) ABSTRACT

The disclosure relates to a method and a device for determining an ambient pressure that prevails around a control unit. The control unit includes a housing, which has an opening, and a membrane having a particular permeability, which covers the opening. A pressure sensor is arranged inside the housing. The method includes: recording a pressure measurement value with the pressure sensor, the pressure measurement value being characteristic of an internal pressure inside the housing; determining a correction value, which includes a constant and a variable; and determining the ambient pressure by way of the pressure measurement value that has been determined and the correction value that has been determined.

### CROSS-REFERENCE TO RELATED APPLICATIONS

This application claims the benefit of PCT Application PCT/EP2021/087193, filed Dec. 22, 2021, which claims priority to German Application 10 2021 200 536.5, filed Jan. 21, 2021. The disclosures of the above applications are incorporated herein by reference.

### TECHNICAL FIELD

The present disclosure relates to a method and a device for determining an ambient pressure prevailing around a control unit. The control unit includes a housing that has an opening, and a membrane having a particular permeability, which covers the opening, where a pressure sensor is arranged inside the housing.

### BACKGROUND

In conventional control units, for example in control units for an engine or for a vehicle, it is known to arrange a pressure sensor inside a housing of the control unit. The housing conventionally has an opening, so that pressure equilibration or air equilibration can take place between the housing volume inside and the surroundings. Accordingly, the ambient pressure corresponds to the housing internal pressure of the control unit. The pressure sensor, which is conventionally arranged inside the control unit, can accordingly record a measurement signal that is characteristic of the ambient pressure prevailing around the control unit. The pressure sensor is arranged inside the housing of the control unit, since it is thereby protected from soiling and further external effects, for example impacts.

Because of changes in legislation governing the housing of control units in countries or regions worldwide, such as the housing of control units in a motor vehicle (engine control units), it is no longer possible to provide the housing with an opening by which the required pressure equilibration or air equilibration can take place in the conventional way with sufficient speed that a good representation of the prevailing ambient pressure around the control unit is possible with the measurement signal recorded by pressure sensor arranged inside the housing.

This problem has previously been overcome by repositioning the pressure sensor from inside the housing to outside the housing, but such a pressure sensor outside the housing is susceptible to environmental influences, for example soiling or damage.

Therefore, it is desirable to provide a method and a device with which an ambient pressure prevailing around a control unit can advantageously be determined simply and reliably.

### SUMMARY

One aspect of the disclosure provides a method for determining an ambient pressure prevailing around a control unit. The control unit includes a housing, which has an opening and a membrane that covers the opening. The membrane in this case has a particular permeability. The permeability indicates how much fluid (air) can flow from one side of the membrane through the membrane to the other side of the membrane as a function of further properties, for example a temperature difference and pressure difference. The control unit includes a pressure sensor inside the housing, which is adapted to record a measurement signal that is characteristic of the pressure inside the housing.

The method includes recording a pressure measurement value with the pressure sensor, the pressure measurement value being characteristic of an internal pressure inside the housing. According to this method step, the pressure measurement value, which is characteristic of the internal pressure inside the housing, is accordingly recorded by the pressure sensor, which is arranged inside the housing.

The method also includes determining a correction value, which includes a constant and a variable. The correction value is formed, for example, from the constant and the variable. In some examples, it is also conceivable for further constants or further variables to form the correction value as well. The correction value may be determined by the control unit itself.

The method also includes determining the ambient pressure by way of the pressure measurement value that has been determined and the correction value that has been determined. In this step, the ambient pressure is ascertained with the aid of the previously recorded pressure measurement value and the correction value that has been determined. This may, for example, be done in the control unit itself, so that the ambient pressure prevailing around the control unit may be deduced directly by the control unit itself.

The membrane closes the opening that would have allowed pressure equilibration from the surroundings to the internal volume of the housing. The membrane does, however, have a particular permeability so that the ambient pressure would also be adjusted inside the housing over a prolonged time in the event of pressure changes. Because of the membrane, however, the ambient pressure does not immediately correspond to the internal pressure inside the housing in the event of pressure variations of the ambient pressure. The internal pressure correspondingly approaches the ambient pressure in the course of time. This deviation may be equalized, or compensated for, by the method according to the present disclosure. The flow rate of fluid through the membrane is proportional to the pressure difference between the ambient pressure and the housing internal pressure. See the following formula, where dN/dt is the flow rate, pᵢₙₜ is the internal pressure and pₑₓₜ is the ambient pressure.

$$\frac{dN}{dt} ∼ ( {p}_{int} - {p}_{ext} )$$

Accordingly, the flow rate through the membrane is also proportional to the pressure variation of the pressure inside the housing. See the following formula, where dN/dt is the flow rate and dpᵢₙₜ/dt is the variation of the internal pressure as a function of time.

$$\frac{dN}{dt} ∼ \frac{{dp}_{int}}{dt}$$

Accordingly, the external pressure may be determined with the aid of the measured internal pressure and the correction value; the correction value, for example the pressure variation inside the housing, and a constant, which for example involves the permeability of the membrane and the opening size of the opening of the housing are determined. See the following formula, where X is the constant.

$${p}_{ext} = {p}_{int} + X * \frac{{dp}_{int}}{dt}$$

The correction value is correspondingly formed from the constant X and the variable dpᵢₙₜ/dt.

The constant may, for example, be determined during the development of the control instrument with the opening and the membrane, and saved in the control unit itself. In addition, the variable may be determined continually by the control unit itself. Accordingly, the control unit may determine the ambient pressure that exists around the control unit merely with the recorded pressure measurement value of the pressure sensor and the correction value, which is ascertained from the constant and the variable. Overall, despite the legal changes and the resulting arrangement of the membrane on the opening, the ambient pressure may accordingly be determined reliably. In addition, the pressure sensor is arranged inside the housing according to the present disclosure, so that it is advantageously protected from environmental influences, with the result that the method for determining the ambient pressure may robustly be carried out even in the event of adverse environmental influences.

In some examples, the variable of the correction value includes a pressure variation over a time inside the housing, the pressure variation being determined by a profile of the recorded pressure measurement value of the pressure sensor. The recorded pressure measurement value of the pressure sensor may, for example, be recorded inside the control unit itself over a particular period of time, so that the profile of the pressure measurement value is obtained. With the aid of the profile, the pressure variation may accordingly be determined. As already explained, the pressure variation inside the housing is proportional to a pressure difference that arises between the ambient pressure and the pressure inside the housing. Accordingly, by the variable that includes the pressure variation as a function of time inside the housing, the ambient pressure may advantageously be deduced simply. In this case, in some examples, the necessary calculations for determining the ambient pressure are carried out by a microcontroller, which is arranged in the control unit itself. Accordingly, the ambient pressure may advantageously be determined rapidly and accurately. In some examples, in addition or as an alternative, a gradient of the pressure variation as a function of time inside the housing may for example be employed in order to determine the ambient pressure. The gradient, or the slope of the gradient, may in this case provide inferences relating to how great the pressure difference between the ambient pressure and the housing internal pressure is, so that the ambient pressure may in turn be deduced simply and reliably by the pressure measurement value recorded by the pressure sensor.

In some implementations, the constant of the correction value includes a first constant, which involves specific properties of the membrane. Besides the permeability, these specific properties of the membrane may involve geometrical data, for example its thickness, or an ageing function. The first constant may, for example, be determined during the development process of the development of the control unit and saved inside the control unit, in which case it may then be retrieved and used to calculate the ambient pressure. Since the ambient pressure can be determined more accurately when the first constant (for example C) is more accurate, it is accordingly important for the first constant to be determined accurately during the development process and, if possible, for ageing effects also to be taken into account. To this extent, according to the formula above the constant would be formed only from the first constant, that is to say X=C.

In some examples, a temperature sensor is arranged inside the housing, the temperature sensor recording a temperature measurement value that is characteristic of an internal temperature inside the housing, the variable of the correction value includes a temperature variation over a time inside the housing, the temperature variation being determined by a profile of the recorded temperature measurement value of the temperature sensor. The temperature sensor is, for example, arranged primarily inside the housing in order to monitor the internal temperature, so that measures may be initiated if the internal temperature exceeds or falls below a critical limit value, with the result that the control instrument can be protected. The temperature measurement value may be recorded over a particular time, so that a profile of the recorded temperature measurement value is obtained, which may in turn be stored inside the control unit. By way of the profile of the temperature measurement value, the temperature variation inside the housing may be determined. The temperature variation inside the housing may be proportional to a pressure difference between the ambient pressure and the internal pressure inside the housing. Accordingly, the ambient pressure prevailing around the housing may be deduced by the temperature variation. This example is based on the observation according to the following formula, where dT/dt is the pressure variation.

$$( {p}_{int} - {p}_{ext} ) ∼ \frac{dT}{dt}$$

In some examples, for example, a heat source that emits heat, for example a microprocessor, is additionally arranged inside the housing. This additional heat source may be taken into account, so that the ambient pressure may advantageously be determined more accurately and reliably.

In some implementations, the variable of the correction value is a combination of the temperature variation and the pressure variation as a function of time. Accordingly, the pressure measurement value recorded by the pressure sensor and the temperature measurement value recorded by the temperature sensor are in this case used to determine the ambient pressure prevailing around the control unit. In this way, the ambient temperature may be determined more accurately. The ambient pressure may be determined by the following formula, where dpᵢₙₜ/dT is the variable of the correction value and indicates the proportionality of the pressure variation to the temperature variation, and X is the constant of the correction value.

$${p}_{ext} = {p}_{int} + X * \frac{{dp}_{int}}{dT}$$

In some examples, the constant of the correction value includes a second constant, which involves specific properties of the membrane that are used to determine the ambient pressure if the ambient pressure is determined by way of the temperature variation. The second constant D may in this case, for example, likewise be determined during a development process of the control unit and saved inside the control unit, for example on a memory, and used in each case to determine the ambient pressure. The second constant may in this case, for example, additionally include ageing effects, which for example represent a variation of the permeability as a function of time. According to the last formula mentioned above, the constant of the correction value would correspondingly be equal to the first constant, that is to say X=D.

In some implementations, the second constant is determined during a time span within which the control instrument is not moved or is moved only slightly relative to its environment, so that the ambient pressure is constant, the internal temperature initially lying above an ambient temperature and subsequently approaching the ambient temperature. The temperature decrease inside the housing may, for example, be due to the control instrument initially being in operation, for example when the vehicle with the control unit is moving, and subsequently not in operation, for example when the vehicle is stopped. During operation of the control unit, for example, heat is produced inside the control unit by the heat source, so that the temperature inside the control unit rises. Subsequently, for example, the vehicle is stopped and no further heat is produced inside the control unit by the heat source. The temperature inside the housing therefore decreases until the temperature inside the housing has reached the ambient temperature. One essential factor that dictates the approach of the temperature inside the housing to the ambient temperature is the second constant, since equilibration via the membrane takes place because of the temperature difference and the resulting pressure difference between the interior inside the housing and the surroundings. Accordingly, the second constant may advantageously be determined simply, reliably and accurately according to this method.

In some implementations, the first constant is ascertained by way of the second constant that has been determined. The first constant and the second constant are linked to one another via physical parameters, so that the first constant can be determined by way of the second constant that has been determined. The calculation of the second constant may, for example, be carried out by the control unit itself.

In this case, the second constant may be determined continuously over the entire service life of the control unit, so that in particular ageing effects of the membrane may advantageously be represented well, advantageously simply and as a function of the operation or the frequency of use of the control unit, with the result that the ambient pressure can advantageously be determined accurately over the entire service life of the control unit.

In some implementations, the constant of the correction value is a combination of the first constant and the second constant. If, for example, the variable of the correction value is determined by the pressure variation and temperature variation as a function of time, it is in particular advantageous to define the constant of the correction value from a combination of the first constant and the second constant. In this way, the ambient temperature may advantageously be determined accurately and reliably.

Another aspect of the disclosure provides a control unit, which includes a housing that has an opening, and a membrane having a particular permeability, which covers the opening. A pressure sensor and a microcontroller are arranged inside the housing, where the microcontroller is configured to carry out one of the methods mentioned above in order to determine an ambient pressure prevailing around the control unit.

Yet another aspect of the disclosure provides a vehicle that includes the control unit provided.

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1 shows a first schematic representation of a control unit according to a first example.

FIG. 2 shows a second schematic representation of a control unit according to a second example.

Like reference symbols in the various drawings indicate like elements.

### DETAILED DESCRIPTION

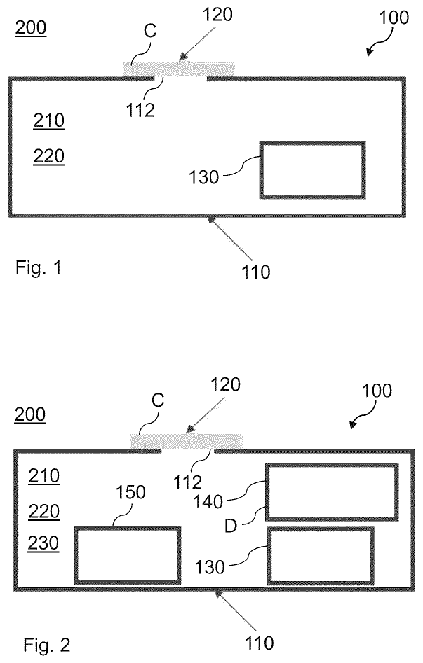

FIG. 1 shows a control unit 100. The control unit 100 includes a housing 110. The housing 110 has an opening 112. The opening 112 is intended for a fluid exchange to be possible between surroundings 200 of the control unit 100 and the interior of the housing 110 of the control unit 100. The control unit 100 furthermore includes a membrane 120. The membrane 120 fully covers the opening 112, so that fluid exchange between the surroundings 200 and the internal volume 220 of the housing 110 of the control unit 100 is possible only through the membrane 120 itself. The membrane 120 has a particular permeability, that is to say a particular perviousness for fluid (for example air). The control unit 100 additionally includes a pressure sensor 130, which is arranged inside the housing 110. The pressure sensor 130 is adapted to record a pressure measurement value that is characteristic of an internal pressure 210 prevailing inside the housing 110. According to the present disclosure, the ambient temperature 200 prevailing around the control unit 100 is determined by way of the recorded pressure measurement value and a correction value that has been determined, which includes a constant and a variable. The constant of the correction value may, for example, be a first constant C. The first constant C may, for example, record parameters of the membrane 120 and be saved inside the control unit 100, and be used to determine the ambient pressure 200. The control unit 100 in this regard includes for example a microcontroller, which performs the calculation for determining the ambient pressure 200. The microcontroller may accordingly receive the pressure measurement value that has been determined by way of the pressure sensor 130. In addition, an internal volume 220 of the housing 110, which remains constant, may be provided to the microcontroller or saved on the microcontroller. By way of the data that are provided and the pressure measurement value that is recorded by way of the pressure sensor 130, the ambient pressure 200 may accordingly be determined.

FIG. 2 differs from FIG. 1 in that a temperature sensor 140, which records a temperature prevailing inside the control unit 100, is additionally arranged inside the control unit 100. In this regard, a temperature measurement value is recorded by way of the temperature sensor 140 and, for example, made available to the microcontroller of the control unit 100. In addition, the control unit 100 includes a heat source 150. The heat source 150 may, for example, be a microcontroller that emits a certain amount of heat during operation of the control unit 100. This heat given off by the microcontroller or the heat source 150 may be calculated and taken into account when determining the temperature measurement value of the temperature sensor 140. In order to determine the ambient pressure 200, the constant of the correction value may additionally or alternatively include a second constant D. By way of the pressure measurement value recorded by the sensor 130 and the correction value, which in some examples is defined by the second constant D and a pressure change as a function of a temperature change, the ambient pressure 200 may accordingly be deduced. The internal pressure 210 inside the housing 110, recorded by way of the pressure sensor 130, may accordingly be provided to the microcontroller. In addition, the internal temperature 230 inside the housing 110, recorded by way of the temperature sensor 140, may be provided to the microcontroller. The internal temperature 230 that has been determined and the internal pressure 210 that has been determined may in this case be recorded as a function of time, so that profiles of the internal pressure 210 and of the internal temperature 230 are recorded. Accordingly, a pressure variation of the internal pressure 210 and a temperature variation of the internal temperature 230 may be deduced, or they may be determined. The variation of the internal pressure 210 and the variation of the internal temperature are in this case proportional to a pressure difference between the ambient pressure and the internal pressure. Because the profile of the internal pressure 210 and the profile of the internal temperature 230 can be determined, or are known, the ambient pressure 200 may accordingly be determined or calculated. The first constant C required for this and the second constant D, for example additionally required for this, may for example be determined during the development of the control unit 100 in the laboratory, or on a test rig, and stored on or inside the control unit 100, for example in a memory, and provided to the microcontroller. The first constant C and the second constant D may, for example, take ageing effects of the membrane 120 into account. This may, for example, also be envisioned if the first constant C or the second constant D, or both constants C, D, are continuously redetermined and resaved during operation of the control unit 100, so that ageing effects of the membrane 120 may advantageously be represented.

A number of implementations have been described. Nevertheless, it will be understood that various modifications may be made without departing from the spirit and scope of the disclosure. Accordingly, other implementations are within the scope of the following claims.

What is claimed is:

1. A method for determining an ambient pressure that prevails around a control unit, the control unit includes a housing having an opening, and a membrane having a particular permeability and covering the opening, a pressure sensor is arranged inside the housing, the method comprises:
recording a pressure measurement value with the pressure sensor, the pressure measurement value being characteristic of an internal pressure inside the housing;
determining a correction value comprising a constant and a variable; and
determining the ambient pressure by the pressure measurement value that has been determined and the correction value that has been determined.

2. The method of claim 1, wherein the variable of the correction value comprises a pressure variation over a time inside the housing, the pressure variation being determined by a profile of the recorded pressure measurement value of the pressure sensor.

3. The method of claim 1, wherein the constant of the correction value comprises a first constant, which involves specific properties of the membrane.

4. The method of claim 2, further comprising:
recording, at a temperature sensor arranged inside the housing, a temperature measurement value that is characteristic of an internal temperature inside the housing,
wherein the variable of the correction value comprising a temperature variation over a time inside the housing, the temperature variation being determined by a profile of the recorded temperature measurement value of the temperature sensor.

5. The method of claim 4, wherein the constant of the correction value comprises a second constant, which involves specific properties of the membrane.

6. The method of claim 5, wherein the second constant is determined during a time span within which the control instrument is not moved or is moved only slightly relative to its environment, so that the ambient pressure is constant, and wherein the internal temperature initially lies above an ambient temperature and subsequently approaches the ambient temperature.

7. The method of claim 5, wherein the first constant is based on the second constant that has been determined.

8. The method of claim 5, wherein the constant of the correction value is a combination of the first constant and the second constant.

9. A control unit comprises:
a housing having an opening;
a membrane having a particular permeability, which covers the opening,
a pressure sensor arranged inside the housing;
a microcontroller arranged inside the housing, the microcontroller configured to carry out a method, the method comprising:
recording a pressure measurement value with the pressure sensor, the pressure measurement value being characteristic of an internal pressure inside the housing;
determining a correction value comprising a constant and a variable; and
determining an ambient pressure by the pressure measurement value that has been determined and the correction value that has been determined.

10. The control unit of claim 9, wherein the variable of the correction value comprises a pressure variation over a time inside the housing, the pressure variation being determined by a profile of the recorded pressure measurement value of the pressure sensor.

11. The control unit of claim 9, wherein the constant of the correction value comprises a first constant, which involves specific properties of the membrane.

12. The control unit of claim 11, further comprising:
a temperature sensor arranged inside the housing, the temperature sensor recording a temperature measurement value that is characteristic of an internal temperature inside the housing,
wherein the variable of the correction value comprises a temperature variation over a time inside the housing, the temperature variation being determined by a profile of the recorded temperature measurement value of the temperature sensor.

13. The control unit of claim 12, wherein the constant of the correction value comprises a second constant, which involves specific properties of the membrane.

14. The control unit of claim 13, wherein the second constant is determined during a time span within which the control instrument is not moved or is moved only slightly relative to its environment, so that the ambient pressure is constant, and wherein the internal temperature initially lies above an ambient temperature and subsequently approaches the ambient temperature.

15. The method of claim 13, wherein the first constant is based on the second constant that has been determined.

16. The method of claim 14, wherein the constant of the correction value is a combination of the first constant and the second constant.

17. A vehicle having a control unit as claimed in claim 8.
